(19) United States
(12) Patent Application Publication
(10) Pub. No.: US 2006/0069178 A1
(43) Pub. Date: Mar. 30, 2006

(54) Method for polymerizing ophthalmic devices

(75) Inventors: Sanjay Rastogi, Rochester, NY (US); Charles P. Henning, Fairport, NY (US); Mahendra P. Nandu, Pittsford, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/208,061

(22) Filed: Aug. 19, 2005

Related U.S. Application Data
(60) Provisional application No. 60/613,096, filed on Sep. 24, 2004.

(51) Int. Cl. C03C 25/10

(52) U.S. Cl. 522/172

(57) ABSTRACT

A method involves providing a monomer mixture comprising a biomedical device-forming monomer and a UV absorbing agent; and exposing the monomer mixture to an electron beam to cure the monomer mixture.

This application claims the benefit under 35 USC 119(e) of Provisional Patent Application No. 60/613,096, filed Sep. 24, 2004.

### FIELD OF THE INVENTION

This invention relates to a method for polymerizing a monomer mixture to form an ophthalmic lens including a UV absorber, wherein the monomer mixture is exposed to electron beam radiation.

### BACKGROUND OF THE INVENTION

Biomedical devices are those intended to contact body fluids or body tissue. Such devices include ophthalmic lenses such as contact lenses and intraocular lenses. These lenses may include a UV absorbing agent in the lens to absorb light in the ultraviolet region of the spectrum, more particularly, to absorb light in the region of about 200 to 400 nm and, especially, about 290 to 400 nm. Representative UV absorbing materials for such lens applications are described in U.S. Pat. No. 4,304,895 (Loshaek), U.S. Pat. No. 4,528,311 (Beard et al.) and U.S. Pat. No. 4,719,248 (Bambury et al.).

Generally, such lenses are formed by free radical polymerization of a monomer mixture including desired lens-forming monomers, usually in the presence of heat (thermal polymerization) or a light source (photopolymerization). One particular method for producing contact lenses involves thermal polymerization of the initial monomeric mixture in tubes in a heated water bath to provide rod-shaped articles, which rods are then cut into buttons, the buttons then being lathed into contact lenses; such methods for forming lenses including a UV absorbing agent are illustrated in the aforementioned U.S. Pat. No. 4,304,895 (Loshaek) and U.S. Pat. No. 4,528,311 (Beard et al.). Other methods involve casting the lenses directly in molds, wherein the monomer mixture is charged to the mold and polymerized by exposure to ultraviolet radiation.

Among photopolymerization processes, UV curing (i.e., exposure of the monomer mixture to radiation mainly in the ultraviolet region) of the monomer mixtures has proved very effective. However, for lenses including a UV absorbing agent, problems are encountered when attempting to cure the monomer mixtures since this agent absorbs UV light, thus diminishing the amount of UV light available to effect polymerization and resulting in ineffective or uneven curing of the monomer mixture.

It is also possible to effect photopolymerization using a light source also including light in the visible region of the spectrum, although light in this region is generally less efficient in effecting polymerization of conventional lens-forming monomer mixtures than UV curing. U.S. Pat. No. 4,719,248 (Bambury) and US patents U.S. Pat. Nos. 6,359,024 and 6,465,538 (Lai et al.) report successful polymerization of contact lens compositions including a UV absorbing agent by exposure of the monomer mixture to visible light.

In the case of thermal curing, the monomer mixture generally includes a thermal polymerization initiator. In the case of UV curing or visible light curing, the monomer mixture generally includes a photopolymerization initiator.

This invention recognized it would be desirable to provide a method whereby lenses including a UV absorbing agent can be more effectively polymerized than conventional lens curing methods. This invention also recognized it would be desirable to provide a method of curing lenses that does not require a polymerization initiator.

Various patent publications mention electron beam radiation as a possible energy source for curing biomedical devices such as contact lenses, for example, U.S. Pat. No. 5,981,618 (Martin et al.), U.S. Pat. No. 6,220,845 (Martin et al.), U.S. Pat. No. 6,772,988 (Altmann); U.S. Pat. No. 6,762,264 (Kunzler et al.); U.S. Pat. No. 6,364,934 (Nandu et al.). However, these patent publications clearly prefer UV curing including the use of a photopolymerization initiator.

Various other patent publications disclose the use of high energy radiation to treat a contact lens formulation that has already undergone polymerization. For example, U.S. Pat. No. 4,217,038 (Letter) discloses electron beam radiation in forming a coating on a contact lens; U.S. Pat. No. 5,529,727 (LaBombard et al.) discloses post-treatment of lenses with high energy; and U.S. Pat. No. 4,826,889 (Ellis et al.) and U.S. Pat. No. 4,330,383 (Ellis et al.) disclose irradiation of polymerized contact lens formulations.

U.S. Pat. No. 3,915,609 (Robinson) discloses casting contact lenses from an unpolymerized resin such as silicone gum, to form a silicone rubber, wherein the resin is polymerized by high energy radiation such as an electron beam.

### SUMMARY OF THE INVENTION

This invention provides a method comprising: providing a monomer mixture comprising a biomedical device-forming monomer and a UV absorbing agent; and exposing the monomer mixture to an electron beam to cure the monomer mixture.

Preferred biomedical devices are ophthalmic lenses, especially contact lenses and intraocular lenses. Accordingly, it is preferred that the monomer mixture is charged to a lens-shaped mold cavity of a mold assembly, and exposed to the electron beam while in this mold cavity.

Preferred monomer mixtures are those for forming hydrogels. Accordingly, it is preferred that the monomer mixture includes a hydrophilic lens-forming monomer. The monomer mixture may form a silicone hydrogel, in which case the monomer mixture includes a hydrophilic monomer and a silicone-containing lens-forming monomer.

According to other embodiments, the monomer mixture lacks any polymerization initiator, and the monomer mixture may include a tint agent.

### DETAILED DESCRIPTION OF PREFERRED EMBODIMENTS

The monomer mixtures employed in the invention include conventional device-forming monomers. The following description of preferred embodiments references ophthalmic lenses, such as contact lenses and intraocular lenses, and therefore the device-forming monomers are referred hereinafter as lens-forming monomers.

The lens-forming monomers are monomers that are polymerizable by free radical polymerization, generally including an activated unsaturated radical, and most preferably an ethylenically unsaturated radical. (As used herein, the term “monomer” denotes relatively low molecular weight compounds that are polymerizable by free radical polymerization, as well as higher molecular weight compounds also referred to as “prepolymers”, “macromonomers”, and related terms.)

An especially preferred class of lens-forming monomers are those that form hydrogel copolymers. A hydrogel is a crosslinked polymeric system that can absorb and retain water in an equilibrium state. Accordingly, for hydrogels, the monomer mixture will typically include a hydrophilic monomer. Suitable hydrophilic monomers include: unsaturated carboxylic acids, such as methacrylic and acrylic acids; acrylic substituted alcohols, such as 2-hydroxyethylmethacrylate and 2-hydroxyethylacrylate; vinyl lactams, such as N-vinyl pyrrolidone; and acrylamides, such as methacrylamide and N,N-dimethylacrylamide.

Another preferred class of lens-forming monomers include those that form silicone hydrogel copolymers. Such systems include, in addition to a hydrophilic monomer, a silicone-containing monomer. One suitable class of silicone containing monomers include known bulky, monofunctional polysiloxanylalkyl monomers represented by Formula (I):

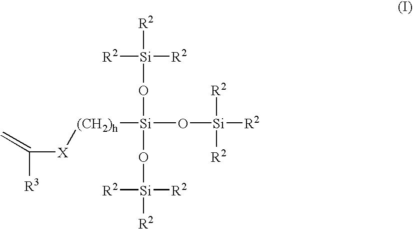

X denotes —COO—, —CONR⁴—, —OCOO—, or —OCONR⁴— where each where R⁴ is H or lower alkyl; R³ denotes hydrogen or methyl; h is 1 to 10; and each R² independently denotes a lower alkyl or halogenated alkyl radical, a phenyl radical or a radical of the formula
—Si(R⁵)₃
wherein each R⁵ is independently a lower alkyl radical or a phenyl radical. Such bulky monomers specifically include methacryloxypropyl tris(trimethylsiloxy)silane, pentamethyldisiloxanyl methylmethacrylate, tris(trimethylsiloxy)methacryloxy propylsilane, methyldi(trimethylsiloxy)methacryloxymethyl silane, 3-[tris(trimethylsiloxy)silyl]propyl vinyl carbamate, and 3-[tris(trimethylsiloxy)silyl]propyl vinyl carbonate.

Another suitable class is multifunctional ethylenically “end-capped” siloxane-containing monomers, especially difunctional monomers represented Formula (II): 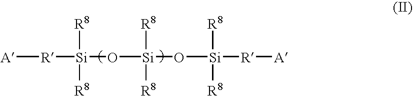
wherein:

each A′ is independently an activated unsaturated group;

each R′ is independently are an alkylene group having 1 to 10 carbon atoms wherein the carbon atoms may include ether, urethane or ureido linkages therebetween;

each R⁸ is independently selected from monovalent hydrocarbon radicals or halogen substituted monovalent hydrocarbon radicals having 1 to 18 carbon atoms which may include ether linkages therebetween, and

a is an integer equal to or greater than 1. Preferably, each R⁸ is independently selected from alkyl groups, phenyl groups and fluoro-substituted alkyl groups. It is further noted that at least one R⁸ may be a fluoro-substituted alkyl group such as that represented by the formula:
-D′-(CF₂)ₛ-M′
wherein:

D′ is an alkylene group having 1 to 10 carbon atoms wherein said carbon atoms may include ether linkages therebetween;

M′ is hydrogen, fluorine, or alkyl group but preferably hydrogen; and

s is an integer from 1 to 20, preferably 1 to 6.

With respect to A′, the term “activated” is used to describe unsaturated groups which include at least one substituent which facilitates free radical polymerization, preferably an ethylenically unsaturated radical. Although a wide variety of such groups may be used, preferably, A′ is an ester or amide of (meth)acrylic acid represented by the general formula: 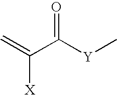
wherein X is preferably hydrogen or methyl, and Y is —O— or —NH—. Examples of other suitable activated unsaturated groups include vinyl carbonates, vinyl carbamates, fumarates, fumaramides, maleates, acrylonitryl, vinyl ether and styryl. Specific examples of monomers of Formula (II) include the following: 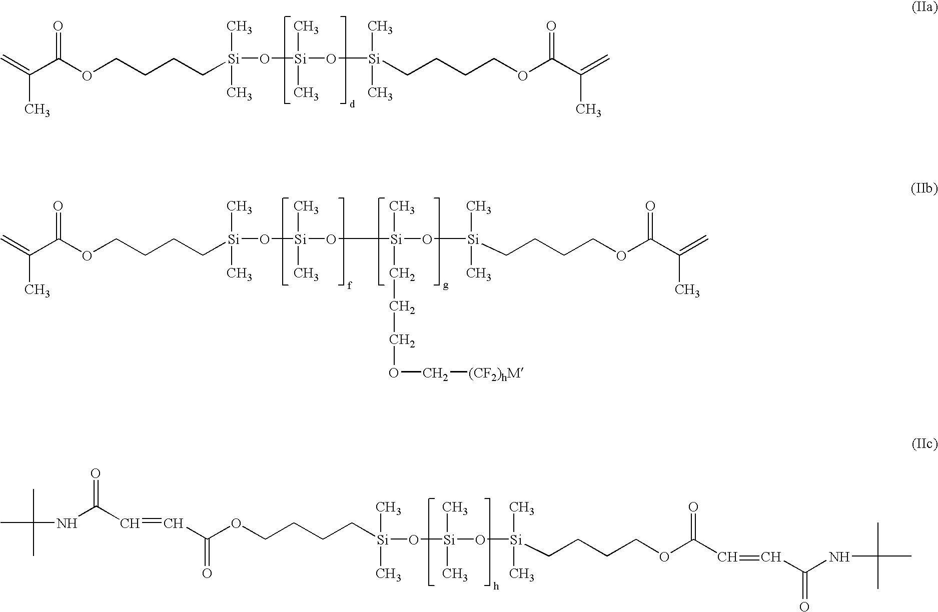
wherein:

d, f, g and k range from 0 to 250, preferably from 2 to 100; h is an integer from 1 to 20, preferably 1 to 6; and

M′ is hydrogen or fluorine.

A further suitable class of silicone-containing monomers includes monomers of the Formulae (IIIa) and (IIIb):
E′(*D*A*D*G)ₐ*D*A*D*E′; or (IIIa)
E′(*D*G*D*A)ₐ*D*G*D*E′; (IIIb)
wherein:

D denotes an alkyl diradical, an alkyl cycloalkyl diradical, a cycloalkyl diradical, an aryl diradical or an alkylaryl diradical having 6 to 30 carbon atoms;

G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;

* denotes a urethane or ureido linkage;

a is at least 1;

A denotes a divalent polymeric radical of the formula: 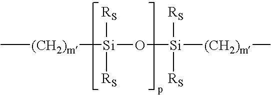
wherein:

each R² independently denotes an alkyl or fluoro-substituted alkyl group having 1 to 10 carbon atoms which may contain ether linkages between carbon atoms;

m′ is at least 1; and

p is a number which provides a moiety weight of 400 to 10,000;

each E′ independently denotes a polymerizable unsaturated organic radical represented by the formula: 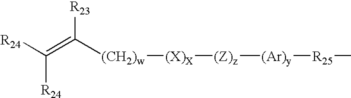
wherein:

R₂₃ is hydrogen or methyl;

R₂₄ is hydrogen, an alkyl radical having 1 to 6 carbon atoms, or a —CO—Y—R₂₆ radical wherein Y is —O—, —S— or —NH—;

R₂₅ is a divalent alkylene radical having 1 to 10 carbon atoms; R₂₆ is a alkyl radical having 1 to 12 carbon atoms; X denotes —CO— or —OCO—; Z denotes —O— or —NH—; Ar denotes an aromatic radical having 6 to 30 carbon atoms; w is 0 to 6; x is 0 or 1; y is 0 or 1; and z is 0 or 1.

A specific urethane monomer is represented by the following: 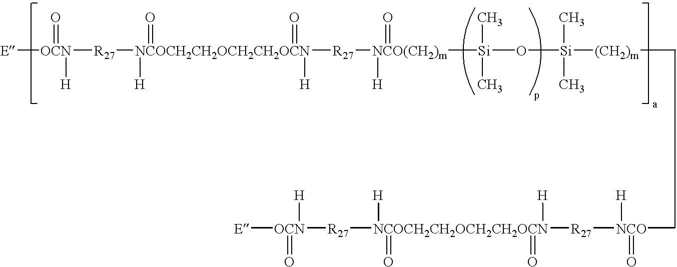
wherein m is at least 1 and is preferably 3 or 4, a is at least 1 and preferably is 1, p is a number which provides a moiety weight of 400 to 10,000 and is preferably at least 30, R₂₇ is a diradical of a diisocyanate after removal of the isocyanate group, such as the diradical of isophorone diisocyanate, and each E″ is a group represented by:

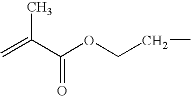

Other silicone-containing monomers include the silicone-containing monomers described in U.S. Pat. Nos. 5,034,461, 5,610,252 and 5,496,871, the disclosures of which are incorporated herein by reference. Other silicone-containing monomers are well-known in the art.

In the case of hydrogels, either the silicone-containing monomer or the hydrophilic monomer may function as a crosslinking agent (a crosslinker being defined as a monomer having multiple polymerizable functionalities) or a separate crosslinker may be employed.

The monomer mixtures include a UV-absorbing agent, defined as an agent that, when incorporated in the final lens, is capable of reducing (or blocking) at least 70% percent of light in the region of 200 to 400 nm, more preferably at least 70% of light in the region of 320 to 400 nm and at least 90% of light in the region of 290 to 320 nm. The invention is suitable for monomer mixtures including any conventional UV absorbing agent. One general class of such agents are non-polymerizable absorbers such as 2,2-drihydoxy-4,4-dimethoxy-benzophenone, and 2,2-dihydoxy-4-methoxy-benzophenone. Preferred UV absorbing agents are those that include an activated unsaturated group (preferably, an ethylenically unsaturated radical) that is reactive with the lens-forming monomers, whereby the UV absorbing agent is copolymerized with the lens-forming monomers. Representative polymerizable UV absorbing materials for such lens applications are described in U.S. Pat. No. 4,304,895 (Loshaek), U.S. Pat. No. 4,528,311 (Beard et al.), U.S. Pat. No. 4,716,234 (Dunks et al.), U.S. Pat. No. 4,719,248 (Bambury et al.), U.S. Pat. No. 3,159,646 (Milionis et al.) and U.S. Pat. No. 3,761,272 (Manneus et al.), the disclosures of which are incorporated herein by reference. Specific examples include: benzotriazole-containing monomers such as 2-(2′-hydroxy-5′-methacrylamidophenyl)-5-chlorobenzotriazole, 2-(2′-hydroxy-5′-methacrylamidophenyl)-5-methoxybenzotriazole, 2-(2′-hydroxy-5′-methacryloxypropyl-3′-t-butylphenyl)-5-chlorobenzotriazole, 2-(2′-hydroxy-5′-methacryloxyethylphenyl)benzotriazole, 2-(2′-hydroxy-5′-methacryloxypropylphenyl)benzotriazole; and the polymerizable benzophenones described in U.S. Pat. No. 4,304,895.

The monomer mixtures may also include a tinting agent, defined as an agent that, when incorporated in the final lens, imparts some degree of color to the lens. The invention is applicable to conventional tinting agents known in the art, including non-polymerizable agents, or polymerizable agents that include an activated unsaturated group that is reactive with the lens-forming monomers. One preferred example of this latter class is the compound 1,4-bis(4-(2-methacryloxyethyl)phenylamino)anthraquinone, a blue visibility-tinting agent disclosed in U.S. Pat. No. 4,997,897.

As mentioned, photopolymerization of monomer mixtures to form lenses by UV curing has proved very effective, however, for lenses including a UV absorbing agent, ineffective or uneven curing is encountered since this agent absorbs UV light. The invention provides a method whereby lenses including a UV absorbing agent can be effectively polymerized by free radical polymerization and without the use of a polymerization initiator.

Generally, the monomer mixtures is charged to a mold, and then subjected to the electron beam to effect curing of the monomer mixture in the mold. Various processes are known for curing a monomeric mixture in the production of contact lenses, including spincasting and static casting. Spincasting methods involve charging the monomer mixture to a mold, and spinning the mold in a controlled manner while curing the monomer mixture. Static casting methods involve charging the monomer mixture between two mold sections, one mold section shaped to form the anterior lens surface and the other mold section shaped to form the posterior lens surface, and curing the monomer mixture contained in the mold assembly. Such methods are described in U.S. Pat. Nos. 3,408,429, 3,660,545, 4,113,224, 4,197,266, and 5,271,875.

For the present invention, various available electron beam sources may be used. For example, some apparatus generate electrons from a heated filament (e.g., tungsten) or cathode, and the electrons are accelerated with an electric potential, generally in the range of 2.5 to 10 MeV. The resultant beam of accelerated electrons is focused on the monomer mixture to effect curing.

Free radicals are provided by the stream of accelerated electrons, whereby the monomers are then co-polymerized with one another. Accordingly, it is unnecessary to employ polymerization initiators as in conventional curing of contact lens formulations since free radicals are provided by the stream of accelerated electrons. Generally, the electron beam will be directed to the monomer mixture through the posterior or the anterior mold, so the electric potential of the electron beam should be sufficient so that the stream of accelerated electrons penetrates the molds containing the monomer mixture to be cured. A further advantage of this invention is that the electron beam can be highly focused at the target monomer mixture. Also, if desired, the electron beam can be directed through both the anterior and the posterior molds to achieve efficient cure of the monomer mixture contained in this mold assembly.

Suppliers of electron beam apparatus and services include the following: Radiation Dynamics, Inc. (Edgewood, N.Y., USA); WD Technical Services (Oakland, Calif., USA); Energy Sciences, Inc. (Wilmington, Mass., USA); and L & W Research Inc. (West Haven, Conn., USA).

Although the invention has been described in connection with various preferred embodiments, numerous variations will be apparent to a person of ordinary skill in the art given the present description, without departing from the spirit of the invention and the scope of the appended claims.

We claim:

1. A method comprising:
providing a monomer mixture comprising a biomedical device-forming monomer and a UV absorbing agent; and
exposing the monomer mixture to an electron beam to cure the monomer mixture.

2. The method of claim 1, wherein the monomer mixture is charged to a lens-shaped mold cavity of a mold assembly, and exposed to the electron beam while in the mold cavity.

3. The method of claim 2, wherein the mold cavity is formed between a first mold section having a molding surface shaped to provide a posterior contact lens surface and a second mold section having a molding surface shaped to provide an anterior contact lens surface.

4. The method of claim 2, wherein the mold cavity is formed between a first mold section having a molding surface shaped to provide a posterior intraocular lens surface and a second mold section having a molding surface shaped to provide an anterior intraocular lens surface.

5. The method of claim 1, wherein the monomer mixture includes a hydrophilic lens-forming monomer.

6. The method of claim 5, wherein the monomer mixture further includes a silicone-containing lens-forming monomer.

7. The method of claim 1, wherein the monomer mixture lacks any polymerization initiator.

8. The method of claim 1, wherein the monomer mixture includes at least one member selected from the group consisting of a hydrophilic device-forming monomer, and a silicone-containing device-forming monomer.

9. The method of claim 1, wherein the monomer mixture further comprises a tint agent.

10. A method comprising:
providing a monomer mixture comprising a biomedical device-forming monomer; and
exposing the monomer mixture to an electron beam to cure the monomer mixture, wherein the monomer mixture lacks any polymerization initiator.

11. The method of claim 10, wherein the monomer mixture is charged to a lens-shaped mold cavity of a mold assembly, and exposed to the electron beam while in the mold cavity.

12. The method of claim 11, wherein the mold cavity is formed between a first mold section having a molding surface shaped to provide a posterior contact lens surface and a second mold section having a molding surface shaped to provide an anterior contact lens surface.

13. The method of claim 11, wherein the mold cavity is formed between a first mold section having a molding surface shaped to provide a posterior intraocular lens surface and a second mold section having a molding surface shaped to provide an anterior intraocular lens surface.

14. The method of claim 10, wherein the monomer mixture includes a hydrophilic lens-forming monomer.

15. The method of claim 14, wherein the monomer mixture further includes a silicone-containing lens-forming monomer.

16. The method of claim 10, wherein the monomer mixture includes at least one member selected from the group consisting of a hydrophilic device-forming monomer, and a silicone-containing device-forming monomer.

17. The method of claim 10, wherein the monomer mixture further comprises a tint agent.
